(19) United States
(12) Patent Application Publication
(10) Pub. No.: US 2021/0156817 A1
(43) Pub. Date: May 27, 2021

(54) CERAMIC STRUCTURED BODY AND SENSOR ELEMENT OF GAS SENSOR

(71) Applicant: NGK INSULATORS, LTD., Nagoya-shi (JP)

(72) Inventors: Megumi FUJISAKI, Kuwana-shi (JP); Mika TAKEUCHI, Susono-shi (JP); Takahiro TOMITA, Chita-shi (JP)

(21) Appl. No.: 17/168,330

(22) Filed: Feb. 5, 2021

Related U.S. Application Data
(63) Continuation of application No. PCT/JP2019/037924, filed on Sep. 26, 2019.

(30) Foreign Application Priority Data
Sep. 28, 2018 (JP) PCT/JP2018/036412

(51) Int. Cl. G01N 27/407; C04B 38/00; G01N 27/409; G01N 27/41; G01N 27/419

(52) U.S. Cl. CPC G01N 27/4077; C04B 38/00; G01N 27/409; G01N 27/4074; G01N 27/419; G01N 27/4071; G01N 27/41

(57) ABSTRACT

A sensor element of a gas sensor includes: an element base which is a ceramic structured body including a detection part of detecting a target measurement gas component; an outer protective layer which is a porous layer provided in at least a part of an outermost peripheral portion of the element base; and an inner protective layer which is a porous layer having a degree of porosity of 30% to 85%, which is larger than a degree of porosity of the outer protective layer, inside the outer protective layer, wherein an average fine pore diameter of the inner protective layer is equal to or larger than 0.5 μm and equal to or smaller than 5.0 μm.

### CROSS-REFERENCE TO RELATED APPLICATION

This application is a continuation application of PCT/JP2019/037924, filed on Sep. 26, 2019, which claims the benefit of priority of international Application No. PCT/JP2018/036412, filed on Sep. 28, 2018, the entire contents of which are incorporated herein by reference.

### BACKGROUND OF THE INVENTION

### Field of the Invention

The present invention relates to a protective layer of a ceramic structured body, and particularly to suppression of ingress of fluid inside.

### Description of the Background Art

Conventionally, as a gas sensor for determining concentration of a desired gas component in a measurement gas such as exhaust gas from an internal combustion, a gas sensor that includes a sensor element made of an oxygen-ion conductive solid electrolyte, such as zirconia (ZrO₂), and including some electrodes on the surface and the inside thereof has been widely known. A sensor element having an elongated planar element shape and including a protective layer (porous protective layer) made up of a porous body on an end portion on a side in which a gas inlet for introducing the measurement gas is provided has already been known (see Japanese Patent No. 5218477, for example).

Japanese Patent No. 5218477 discloses a gas sensor element adopting a configuration that a space between large-sized grains, an average size of which is 22 μm±4 μm, is filled with minute-sized grains of 10 μm or less, thereby intending to prevent water-induced cracking. Herein, the water-induced cracking is a phenomenon that water droplets occurring by condensation of moisture vapor in the measurement gas adhere to the sensor element heated to a high temperature, thus thermal shock in accordance with a local temperature reduction is applied to the sensor element, and the sensor element cracks.

However, in the porous protective layer disclosed in Japanese Patent No. 5218477, a size of a pore (pore diameter) is estimated to be a large value, which is 10 μm or more, thus the porous protective layer has a low thermal insulation property, and a sufficient water resistance property is not necessarily obtained. There is also concern that water enters inside the element from the pore.

A sensor element of an oxygen sensor having a bottomed cylindrical element shape and provided with a poisoning prevention layer on a surface thereof also has already been known (see Japanese Patent No. 4440822, for example).

However, Japanese Patent No. 4440822 does not describe water-induced cracking at all, but describes that it is necessary for a poisoning prevention layer to have a hole substantially equal to a size distribution of ceramic grains (equal to or larger than 10 μm and equal to or smaller than 50 μm) which are a kind of constituent elements of the poisoning prevention layer. According to the latter condition, there is concern that water enters inside the element from the hole.

### SUMMARY

The present invention is therefore has been made to solve problems as described above, and it is an object of the present invention to provide a technique of appropriately suppressing ingress of water inside in a ceramic structured body such as a sensor element of a gas sensor, for example.

In order to solve the above problems, a first aspect of the present invention is a ceramic structured body including a first porous layer in at least a part of an outermost peripheral portion; and a second porous layer having a degree of porosity of 30% to 85%, which is larger than a degree of porosity of the first porous layer, inside the first porous layer, wherein an average fine pore diameter of the second porous layer is equal to or larger than 0.5 μm and equal to or smaller than 5.0 μm.

A second aspect of the present invention is the ceramic structured body according to the first aspect, wherein the second porous layer includes: aggregate particles each having a diameter of 1.0 μm to 10 μm; and binding material particles each having a diameter equal to or larger 10 nm and equal to or smaller than 1.0 μm.

A third aspect of the present invention is the ceramic structured body according to the second aspect, wherein the aggregate particles are particles of at least one oxide selected from a group of alumina, spinel, titania, zirconia, magnesia, mullite, and cordierite, and the binding material particles are particles of at least one oxide selected from a group of alumina, spinel, titania, zirconia, magnesia, mullite, and cordierite.

A fourth aspect of the present invention is the ceramic structured body according to the first to third aspects, wherein a degree of porosity of the second porous layer is 50% to 70%.

A fifth aspect of the present invention is the ceramic structured body according to the first to fourth aspects, wherein an average fine pore diameter of the second porous layer is equal to or larger than 0.6 μm and equal to or smaller than 3.4 μm.

A sixth aspect of the present invention is the ceramic structured body according to the fifth aspect, wherein a degree of porosity of the second porous layer is 60% to 70%.

A seventh aspect of the present invention is a sensor element of a gas sensor including: an element base which is a ceramic structured body including a detection part of detecting a target measurement gas component; an outer protective layer which is a porous layer provided in at least a part of an outermost peripheral portion of the element base; and an inner protective layer which is a porous layer having a degree of porosity of 30% to 85%, which is larger than a degree of porosity of the outer protective layer, inside the outer protective layer, wherein an average fine pore diameter of the inner protective layer is equal to or larger than 0.5 μm and equal to or smaller than 5.0 μm.

According to the first to sixth aspects of the present invention, water resistance in the ceramic structured body is increased.

According to the seventh aspect of the present invention, water resistance in the sensor element is increased, thus the sensor element preferably suppressing ingress of water inside can be achieved.

### BRIEF DESCRIPTION OF THE DRAWINGS

FIG. 1 is a schematic external perspective view of a sensor element 10.

FIG. 2 is a schematic diagram illustrating a configuration of a gas sensor 100 including a sectional view taken along a longitudinal direction of the sensor element 10.

FIG. 3 is a diagram schematically illustrating a detail configuration of an inner protective layer 21 and an outer protective layer 22.

FIGS. 4A and 4B are diagrams for description of an effect of the outer protective layer 22.

FIG. 5 is a diagram illustrating a flow of processing at a manufacture of the sensor element 10.

FIG. 6 is a diagram of plotting a measurement result of the sensor elements 10 of No. 1 to No. 17 illustrated in Table 1, a lateral axis indicating an average fine pore diameter and a vertical axis indicating a degree of porosity.

### DESCRIPTION OF THE PREFERRED EMBODIMENTS

<Overview of Sensor Element and Gas Sensor>

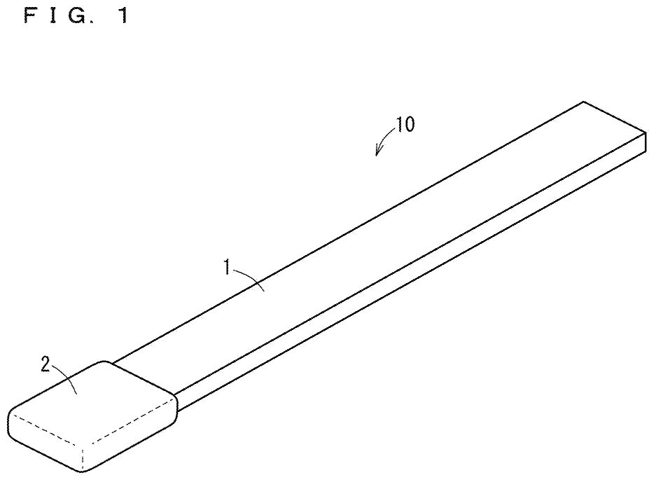

FIG. 1 is a schematic external perspective view of a sensor element (gas sensor element) 10 as one configuration of a ceramic structured body including a surface structure according to an embodiment of the present invention. In the present embodiment, the ceramic structured body indicates a structure including ceramic as a main constituent material while having constituent element other than a ceramic component (for example, an electrode or an electrical wiring made up of metal, for example) inside or on a surface thereof.

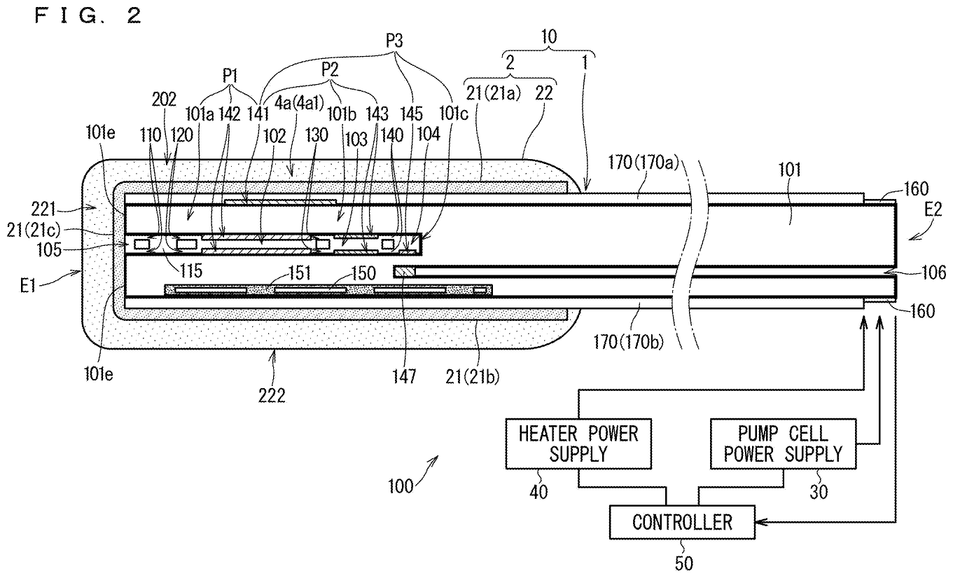

FIG. 2 is a schematic diagram illustrating a configuration of a gas sensor 100 including a sectional view taken along a longitudinal direction of the sensor element 10. The sensor element 10 is a main component of the gas sensor 100 detecting a predetermined gas component in a measurement gas, and measuring concentration thereof. The sensor element 10 is a so-called limiting current gas sensor element.

The gas sensor 100 mainly includes a pump cell power supply 30, a heater power supply 40, and a controller 50 in addition to the sensor element 10.

As illustrated in FIG. 1, the sensor element 10 schematically includes a configuration that a side of one end portion of an elongated planar element base 1 is covered by a porous leading-end protective layer 2.

As illustrated in FIG. 2, the element base 1 is a structure mainly made up of an elongated planar ceramic body 101 and includes a main surface protective layer 170 on two main surfaces of the ceramic body 101, and the sensor element 10 is provided with the leading-end protective layer 2 on an end surface of one leading end portion (a tip end surface 101e of the ceramic body 101) and on an outer sides of four side surfaces. The four side surfaces of the sensor element 10 (or the element base 1, or the ceramic body 101) other than opposite end surfaces in the longitudinal direction thereof are hereinafter simply referred to as side surfaces of the sensor element 10 (or the element base 1, or the ceramic body 101).

The ceramic body 101 is made of ceramic containing, as a main component, zirconia (yttrium stabilized zirconia), which is an oxygen-ion conductive solid electrolyte. Various components of the sensor element 10 are provided outside and inside the ceramic body 101. The ceramic body 101 having the configuration is dense and airtight. The configuration of the sensor element 10 illustrated in FIG. 2 is just an example, and a specific configuration of the sensor element 10 is not limited to this configuration.

The sensor element 10 illustrated in FIG. 2 is a so-called serial three-chamber structure type gas sensor element including a first internal chamber 102, a second internal chamber 103, and a third internal chamber 104 inside the ceramic body 101. That is to say, in the sensor element 10, the first internal chamber 102 communicates, through a first diffusion control part 110 and a second diffusion control part 120, with a gas inlet 105 opening to the outside on a side of one end portion E1 of the ceramic body 101 (to be precise, communicating with the outside through the leading-end protective layer 2), the second internal chamber 103 communicates with the first internal chamber 102 through a third diffusion control part 130, and the third internal chamber 104 communicates with the second internal chamber 103 through a fourth diffusion control part 140. A path from the gas inlet 105 to the third internal chamber 104 is also referred to as a gas distribution part. In the sensor element 10 according to the present embodiment, the distribution part is provided straight along the longitudinal direction of the ceramic body 101.

The first diffusion control part 110, the second diffusion control part 120, the third diffusion control part 130, and the fourth diffusion control part 140 are each provided as two slits vertically arranged in FIG. 2. The first diffusion control part 110, the second diffusion control part 120, the third diffusion control part 130, and the fourth diffusion control part 140 provide predetermined diffusion resistance to a measurement gas passing therethrough. A buffer space 115 having an effect of buffering pulsation of the measurement gas is provided between the first diffusion control part 110 and the second diffusion control part 120.

An external pump electrode 141 is provided on an outer surface of the ceramic body 101, and an internal pump electrode 142 is provided in the first internal chamber 102. Furthermore, an auxiliary pump electrode 143 is provided in the second internal chamber 103, and a measurement electrode 145, which is a detection part of directly detecting a target measurement gas component, is provided in the third internal chamber 104. In addition, a reference gas inlet 106 which communicates with the outside and through which a reference gas is introduced is provided on a side of the other end portion E2 of the ceramic body 101, and a reference electrode 147 is provided in the reference gas inlet 106.

In a case where a target of measurement of the sensor element 10 is NOx in the measurement gas, for example, concentration of a NOx gas in the measurement gas is calculated by a process as described below.

First, the measurement gas introduced into the first internal chamber 102 is adjusted to have an approximately constant oxygen concentration by a pumping action (pumping in or out of oxygen) of a main pump cell P1, and then introduced into the second internal chamber 103. The main pump cell P1 is an electrochemical pump cell including the external pump electrode 141, the internal pump electrode 142, and a ceramic layer 101a that is a portion of the ceramic body 101 existing between these electrodes. In the second internal chamber 103, oxygen in the measurement gas is pumped out of the element by a pumping action of an auxiliary pump cell P2 that is also an electrochemical pump cell, so that the measurement gas is in a sufficiently low oxygen partial pressure state. The auxiliary pump cell P2 includes the external pump electrode 141, the auxiliary pump electrode 143, and a ceramic layer 101b that is a portion of the ceramic body 101 existing between these electrodes.

The external pump electrode 141, the internal pump electrode 142, and the auxiliary pump electrode 143 are each formed as a porous cermet electrode (e.g., a cermet electrode made of ZrO₂ and Pt that contains Au of 1%). The internal pump electrode 142 and the auxiliary pump electrode 143 to be in contact with the measurement gas are each formed using a material having weakened or no reducing ability with respect to a NOx component in the measurement gas.

NOx in the measurement gas caused by the auxiliary pump cell P2 to be in the low oxygen partial pressure state is introduced into the third internal chamber 104, and reduced or decomposed by the measurement electrode 145 provided in the third internal chamber 104. The measurement electrode 145 is a porous cermet electrode also functioning as a NOx reduction catalyst that reduces NOx existing in the atmosphere in the third internal chamber 104. During the reduction or decomposition, a potential difference between the measurement electrode 145 and the reference electrode 147 is maintained constant. Oxygen ions generated by the above-mentioned reduction or composition are pumped out of the element by a measurement pump cell P3. The measurement pump cell P3 includes the external pump electrode 141, the measurement electrode 145, and a ceramic layer 101c that is a portion of the ceramic body 101 existing between these electrodes. The measurement pump cell P3 is an electrochemical pump cell pumping out oxygen generated by decomposition of NOx in the atmosphere around the measurement electrode 145.

Pumping (pumping in or out of oxygen) of the main pump cell P1, the auxiliary pump cell P2, and the measurement pump cell P3 is achieved, under control performed by the controller 50, by the pump cell power supply (variable power supply) 30 applying voltage necessary for pumping across electrodes included in each of the pump cells. In a case of the measurement pump cell P3, voltage is applied across the external pump electrode 141 and the measurement electrode 145 so that the potential difference between the measurement electrode 145 and the reference electrode 147 is maintained at a predetermined value. The pump cell power supply 30 is typically provided for each pump cell.

The controller 50 detects a pump current Ip2 flowing between the measurement electrode 145 and the external pump electrode 141 in accordance with the amount of oxygen pumped out by the measurement pump cell P3, and calculates a NOx concentration in the measurement gas based on a linear relationship between a current value (NOx signal) of the pump current Ip2 and the concentration of decomposed NOx.

The gas sensor 100 preferably includes a plurality of electrochemical sensor cells, which are not illustrated, detecting the potential difference between each pump electrode and the reference electrode 147, and each pump cell is controlled by the controller 50 based on a signal detected by each sensor cell.

In the sensor element 10, the heater 150 is buried in the ceramic body 101. The heater 150 is provided, below the gas distribution part in FIG. 2, over a range from the vicinity of the one end portion E1 to at least a location of formation of the measurement electrode 145 and the reference electrode 147. The heater 150 is provided mainly to heat the sensor element 10 to enhance oxygen-ion conductivity of the solid electrolyte forming the ceramic body 101 when the sensor element 10 is in use. More particularly, the heater 150 is provided to be surrounded by an insulating layer 151.

The heater 150 is a resistance heating body made, for example, of platinum. The heater 150 generates heat by being powered from the heater power supply 40 under control performed by the controller 50.

The sensor element 10 according to the present embodiment is heated by the heater 150 when being in use so that the temperature at least in a range from the first internal chamber 102 to the second internal chamber 103 becomes 500° C. or more. In some cases, the sensor element 10 is heated so that the temperature of the gas distribution part as a whole from the gas inlet 105 to the third internal chamber 104 becomes 500° C. or more. These are to enhance the oxygen-ion conductivity of the solid electrolyte forming each pump cell and to desirably demonstrate the ability of each pump cell. In this case, the temperature in the vicinity of the first internal chamber 102, which becomes the highest temperature, becomes approximately 700° C. to 800° C.

In the following description, from among the two main surfaces of the ceramic body 101, a main surface (or an outer surface of the sensor element 10 having the main surface) which is located on an upper side in FIG. 2 and on a side where the main pump cell P1, the auxiliary pump cell P2, and the measurement pump cell P3 are mainly provided is also referred to as a pump surface, and a main surface (or an outer surface of the sensor element 10 having the main surface) which is located on a lower side in FIG. 2 and on a side where the heater 150 is provided is also referred to as a heater surface. In other words, the pump surface is a main surface closer to the gas inlet 105, the three internal chambers, and the pump cells than to the heater 150, and the heater surface is a main surface closer to the heater 150 than to the gas inlet 105, the three internal chambers, and the pump cells.

A plurality of electrode terminals 160 are provided on the respective main surfaces of the ceramic body 101 on the side of the other end portion E2 to establish electrical connection between the sensor element 10 and the outside. These electrode terminals 160 are electrically connected to the above-mentioned five electrodes, opposite ends of the heater 150, and a lead for detecting heater resistance, which is not illustrated, through leads provided inside the ceramic body 101, which are not illustrated, to have a predetermined correspondence relationship. Application of a voltage from the pump cell power supply 30 to each pump cell of the sensor element 10 and heating by the heater 150 by being powered from the heater power supply 40 are thus performed through the electrode terminals 160.

The sensor element 10 further includes the above-mentioned main surface protective layers 170 (170a, 170b) on the pump surface and the heater surface of the ceramic body 101. The main surface protective layers 170 are layers made of alumina, having a thickness of approximately 5 μm to 30 μm, and including pores with a degree of porosity of approximately 20% to 40%, and are provided to prevent adherence of any foreign matter and poisoned substances to the main surfaces (the pump surface and the heater surface) of the ceramic body 101 and the external pump electrode 141 provided on the pump surface. The main surface protective layer 170a on the pump surface thus functions as a pump electrode protective layer for protecting the external pump electrode 141.

In the present embodiment, the degree of porosity is obtained by applying a known image processing method (e.g., binarization processing) to a scanning electron microscope (SEM) image of an evaluation target.

The main surface protective layers 170 are provided over substantially all of the pump surface and the heater surface except that the electrode terminals 160 are partially exposed in FIG. 2, but this is just an example. The main surface protective layers 170 may locally be provided in the vicinity of the external pump electrode 141 on the side of the one end portion E1 compared with the case illustrated in FIG. 2.

<Details of Tip End Protective Layer>

In the sensor element 10, the leading-end protective layer 2 is provided around an outermost peripheral portion in a predetermined range from the one end portion E1 of the element base 1 having a configuration as described above. The leading-end protective layer 2 is provided to have a thickness of 100 μm to 1000 μm.

The leading-end protective layer 2 is provided to surround a portion of the element base 1 in which the temperature becomes high (approximately 700° C. to 800° C. at a maximum) when the gas sensor 100 is in use to thereby securing water resistance property in the portion and suppress the occurrence of cracking (water-induced cracking) of the element base 1 due to thermal shock caused by local temperature reduction upon direct exposure of the portion to water.

In addition, the leading-end protective layer 2 is also provided to secure a poisoning resistance property for preventing poisoned substances such as Mg from entering inside the sensor element 10.

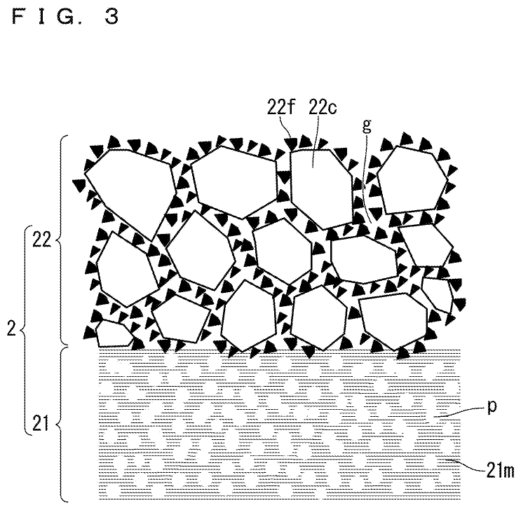

As illustrated in FIG. 2, in the sensor element 10 according to the present embodiment, the leading-end protective layer 2 is made up of an inner leading-end protective layer (inner protective layer) 21 and an outer leading-end protective layer (outer protective layer) 22. FIG. 3 is a diagram schematically illustrating a detail configuration of the inner protective layer 21 and the outer protective layer 22.

The inner protective layer 21 is provided on an outer side of a leading end surface 101e on a side of one end portion E1 and four side surfaces of the element base 1 (an outer periphery of the element base 1 on a side of one end portion E1). FIG. 2 illustrates a portion 21a on a side of the pump surface, a portion 21b on a side of the heater surface, and a portion 21c on a side of the leading end surface 101e in the inner protective layer 21.

As illustrated in FIG. 3, the inner protective layer 21 is a porous layer roughly having a configuration that numerous minute spherical pores p are dispersed in a matrix 21m including an aggregate made up of ceramic having a grain diameter of 1.0 μm to 10 μm and a binding material made up of ceramic having a grain diameter of 0.01 μm to 1.0 μm with a thickness of 50 μm to 950 μm. A degree of porosity is 30% to 85%. Such a configuration is achieved by a forming method described hereinafter.

In the present specification, the grain diameter is defined as a measurement value of a circumcircle of a primary particle which can be visually confirmed in a SEM image of a target evaluation object (measuring points n is equal to or larger than 100). In the case that the primary particle cannot be visually confirmed in a photographing result by a general SEM, the grain diameter may be specified based on an image obtained by a field emission type scanning electron microscope (FE-SEM) or an atomic force microscope (AFM).

More specifically, an average fine pore diameter calculated as an average value of pore diameters, which is a size of the pore p, is equal to or larger than 0.5 μm and equal to or smaller than 5.0 μm, and a neck diameter of the aggregate is equal to or smaller than 2.0 μm. These are appropriately adjusted by adjusting a particle diameter of a pore forming material used at a time of forming the inner protective layer 21. In the present specification, intercept method is used for calculating the pore diameter, that is, an optional straight line is drawn in a SEM image or a FE-SEM image (2500 magnifications) of a target evaluation object, and a length of a segment of a portion of the pore on the straight line is defined as the pore diameter at that position (measuring points n is equal to or larger than 100). An average value of the pore diameters of the individual pores p thus obtained is defined as the average fine pore diameter.

When the average fine pore diameter is set equal to or smaller than 5.0 μm while keeping the degree of porosity at 30% to 85% as the present embodiment, the minute pores p are uniformly dispersed, thus strength of the inner protective layer 21 is increased. A heat transfer path is miniaturized and thermal conductivity is reduced, thus high thermal insulation is further achieved in the inner protective layer 21. The high thermal insulation has an effect of further improving the water resistance property of the sensor element 10. For example, even when there is no difference in the configuration of the outer protective layer 22, the sensor element 10 in which the inner protective layer 21 has the average fine pore diameter of 5.0 μm or less has water resistance superior to the sensor element 10 in which the average fine pore diameter is larger than 5.0 μm. A magnitude of the degree of porosity also has an influence on the thermal insulation property.

Schematically, the sensor element 10 having a smaller pore diameter of the inner protective layer 21 tends to have a lower thermal conductivity and a higher water resistance property. The sensor element 10 having a larger degree of porosity of the inner protective layer 21 has a lower thermal conductivity by reason that a pore increases in the inner protective layer 21, thus tends to have a higher water resistance property.

The sensor element 10 according to the present embodiment has the average fine pore diameter of 0.5 μm to 5.0 μm while keeping the degree of porosity of the inner protective layer 21 at 30% to 85% as described above, thereby increasing the water resistance property.

The average fine pore diameter is preferably 0.6 μm to 3.4 μm. In such a case, the degree of porosity is set to an appropriate value corresponding to the average fine pore diameter, thus the sensor element 10 having the extremely preferable water resistance property can be achieved. The degree of porosity is preferably equal to or larger than 50% and equal to or smaller than 70%. In such a case, the average fine pore diameter is set to an appropriate value corresponding to the degree of porosity, thus the sensor element 10 having the extremely preferable water resistance property can be achieved.

It is more preferable that the average fine pore diameter is 0.6 μm to 3.4 μm and the degree of porosity is equal to or larger than 60% and equal to or smaller than 70%. In such a case, the sensor element 10 having the extremely preferable water resistance property is achieved.

Exemplified as a material of the aggregate is an oxide chemically stable in exhaust gas at high temperature such as alumina, spinel, titania, zirconia, magnesia, mullite, or cordierite. A mixture of plural types of oxide is also applicable.

Exemplified as a material of the binding material is an oxide chemically stable in exhaust gas at high temperature such as alumina, spinel, titania, zirconia, magnesia, mullite, or cordierite. A mixture of plural types of oxide is also applicable.

The inner protective layer 21 also has a role as underlying layer at the time when the outer protective layer 22 is formed with respect to the element base 1. It is only required that the inner protective layer 21 be formed, on the side surfaces of the element base 1, at least in a range surrounded by the outer protective layer 22.

The outer protective layer 22 is provided to have a thickness of 50 μm to 950 μm in an outermost peripheral portion of the element base 1 in a predetermined range from the side of the one end portion E1. In the case illustrated in FIG. 2, the outer protective layer 22 is provided to cover the whole inner protective layer 21 provided on the side of one end portion E1 (of the ceramic body 101) of the element base 1 from an outer side.

As illustrated in FIG. 3, the outer protective layer 22 has a configuration that numerous coarse grains 22c around which numerous minute convex parts made up of microparticles 22f are discretely formed are connected to each other directly or via the microparticles 22f.

A grain diameter of the coarse grain 22c is 5.0 μm to 40 μm, and a grain diameter of the microparticle 22f is equal to or larger than 10 nm and equal to or smaller than 1.0 μm. A weight ratio of the coarse grain 22c to the microparticle 22f (coarse grain/microparticle) is 3 to 35. In addition, a size of the convex part (height from a surface of the coarse grain 22c) is nano-level of 1.0 μm at most, and is preferably equal to or smaller than 500 nm. An average of intervals between the concave parts is approximately 100 nm to 1000 nm.

Exemplified as a material of the coarse grain 22c is an oxide chemically stable in exhaust gas at high temperature such as alumina, spinel, titania, zirconia, magnesia, mullite, or cordierite. A mixture of plural types of oxide is also applicable.

Exemplified as a material of the microparticle 22f is an oxide chemically stable in exhaust gas at high temperature such as alumina, spinel, titania, zirconia, magnesia, mullite, or cordierite. A mixture of plural types of oxide is also applicable.

The outer protective layer 22 satisfying these requirements has characteristics as a porous layer in which gas reaching from outside can pass through a gap g appropriately formed between the grains (mainly a gap between the convex parts made up of the microparticles 22f).

A degree of porosity of the outer protective layer 22 in such a case is preferably 5% to 50%. Furthermore, the degree of porosity of the outer protective layer 22 is preferably smaller than the degree of porosity of the inner protective layer 21. In such a case, so-called anchoring effect acts between the outer protective layer 22 and the inner protective layer 21 as an underlying layer. Due to the action of the anchoring effect, in the sensor element 10, delamination of the outer protective layer 22 from the element base 1 caused by a difference in coefficient of thermal expansion between the outer protective layer 22 and the element base 1 is more suitably suppressed when the sensor element 10 is in use.

In addition, the outer protective layer 22 has a layered structure of a microstructure and a nanostructure in which the numerous minute convex parts made up of the microparticles 22f are formed around the coarse grains 22c, thus its layer surface has a high water-repellent property by so-called lotus effect.

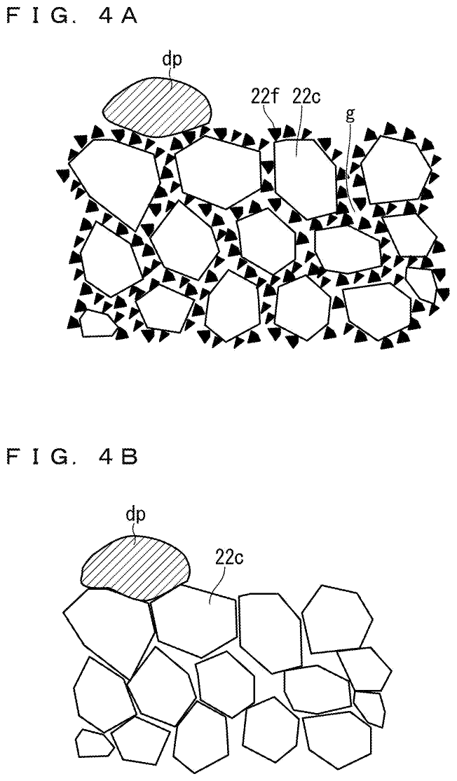

FIGS. 4A and 4B are diagrams for description of the lotus effect in the outer protective layer 22. FIG. 4A indicates a case where a water droplet dp having a size of approximately several μm adheres to the surface of the outer protective layer 22 according to the present embodiment, and FIG. 4B indicates a case where the similar water droplet dp adheres to a surface of a layer formed of only the coarse grains 22c having a size of μm order as with the configuration of a conventional sensor element.

Comparing the both cases, in the former case, the water droplets dp mainly have contact with the nanometer-size convex parts formed of the microparticles 22f. In contrast, in the latter case, the water droplets dp have contact with the coarse grains 22c. A contact angle of the former case is larger than a contact angle of the latter case, thus in the latter case, each water droplet dp cannot keep its shape but easily loses the shape, however, in the former case, a surface tension of the water droplet dp is maintained. That is to say, the shape of the water droplet dp is maintained. In other words, the surface of the outer protective layer 22 illustrated in FIG. 4A has the excellent water-repellent property. In contrast, the conventional configuration illustrated in FIG. 4B has a poor water-repellent property, easily allows the fluid derived from the water droplet dp which has lost its shape to enter inside, and is not preferable.

Thus, the sensor element 10 according to the present embodiment having the combination of such an excellent water-repellent property in the outer protective layer 22 and the miniaturized pore p in the inner protective layer 21 described above suppresses the ingress of the fluid inside the element more appropriately. That is to say, the sensor element 10 according to the present embodiment is excellent in the water resistance, thereby hardly causing the water-induced cracking compared with the conventional element.

When the degree of porosity of the inner protective layer 21 is larger than the degree of porosity of the outer protective layer 22, the inner protective layer 21 has a higher thermal insulation property than the outer protective layer 22 and the main surface protective layer 170. This configuration also contributes to the improvement of the water resistance property of the sensor element 10.

<Process of Manufacturing Sensor Element>

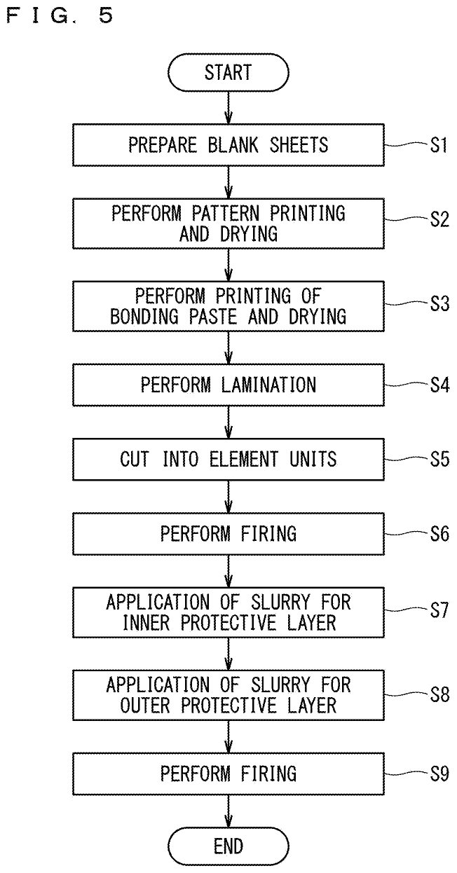

One example of a process of manufacturing the sensor element 10 having a configuration and features as described above will be described next. FIG. 5 is a flowchart of processing at the manufacture of the sensor element 10.

At the manufacture of the element base 1, a plurality of blank sheets (not illustrated) being green sheets containing the oxygen-ion conductive solid electrolyte, such as zirconia, as a ceramic component and having no pattern formed thereon are prepared first (Step S1).

The blank sheets have a plurality of sheet holes used for positioning in printing and lamination. The sheet holes are formed to the blank sheets in advance prior to pattern formation through, for example, punching by a punching machine when the sheets are in the form of the blank sheets. Green sheets corresponding to a portion of the ceramic body 101 in which an internal space is formed also include penetrating portions corresponding to the internal space formed in advance through, for example, punching as described above. The blank sheets are not required to have the same thickness, and may have different thicknesses in accordance with corresponding portions of the element base 1 eventually formed.

After preparation of the blank sheets corresponding to the respective layers, pattern printing and drying are performed on the individual blank sheets (Step S2). Specifically, a pattern of various electrodes, a pattern of the heater 150 and the insulating layer 151, a pattern of the electrode terminals 160, a pattern of the main surface protective layers 170, a pattern of internal wiring, which is not illustrated, and the like are formed. Application or placement of a sublimable material (vanishing material) for forming the first diffusion control part 110, the second diffusion control part 120, the third diffusion control part 130, and the fourth diffusion control part 140 is also performed at the time of pattern printing.

The patterns are printed by applying pastes for pattern formation prepared in accordance with the properties required for respective formation targets onto the blank sheets using known screen printing technology. A known drying means can be used for drying after printing.

After pattern printing on each of the blank sheets, printing and drying of a bonding paste are performed to laminate and bond the green sheets (Step S3). The known screen printing technology can be used for printing of the bonding paste, and the known drying means can be used for drying after printing.

The green sheets to which an adhesive has been applied are then stacked in a predetermined order, and the stacked green sheets are crimped under predetermined temperature and pressure conditions to thereby form a laminated body (Step S4). Specifically, crimping is performed by stacking and holding the green sheets as a target of lamination on a predetermined lamination jig, which is not illustrated, while positioning the green sheets at the sheet holes, and then heating and pressurizing the green sheets together with the lamination jig using a lamination machine, such as a known hydraulic pressing machine. The pressure, temperature, and time for heating and pressurizing depend on a lamination machine to be used, and these conditions may be determined appropriately to achieve good lamination.

After the laminated body is obtained as described above, the laminated body is cut out at a plurality of locations to obtain unit bodies eventually becoming the individual element bases 1 (Step S5).

The element bodies which have been obtained are then fired at a firing temperature of approximately 1300° C. to 1500° C. (step S6). The element base 1 is thereby manufactured. That is to say, the element base 1 is generated by integrally firing the ceramic body 101 made of the solid electrolyte, the electrodes, and the main surface protective layers 170. Integral firing is performed in this manner, so that the electrodes each have sufficient adhesion strength in the element base 1.

After the element base 1 is manufactured in the above-mentioned manner, formation of the leading-end protective layer 2 is then performed on the element base 1. The leading-end protective layer 2 is formed by applying slurry which is prepared in advance for the inner protective layer on a formation target location of the inner protective layer 21 in the element base 1 (Step S7), then applying slurry which is similarly prepared in advance for the outer protective layer on a formation target location of the outer protective layer 22 in the element base 1 (Step S8), and subsequently firing the element base 1 in which the application film is formed in such a manner (Step S9).

The materials for slurry for forming the inner protective layer and slurry for forming the outer protective layer are exemplified as follows.

A material of the aggregate (the inner protective layer) and a material of the coarse particle (the outer protective layer): an oxide powder chemically stable in exhaust gas at high temperature such as alumina, spinel, titania, zirconia, magnesia, mullite, or cordierite;

A material of the binding material (the inner protective layer) and a material of the microparticle (the outer protective layer): an oxide powder chemically stable in exhaust gas at high temperature such as alumina, spinel, titania, zirconia, magnesia, mullite, or cordierite;

A pore forming material (only the inner protective layer): it is not particularly designated, but a polymer pore forming material or carbon powder, for example, can be used. For example, acrylic resin, melamine resin, polyethylene particles, polystyrene particles, carbon black powder, or black lead powder can be used;

Binder (common in both layers): there is no particular limitation, but inorganic binder is preferable in terms of improvement of the strength of the inner protective layer 21 obtained by firing. For example, alumina sol, silica gel, or titania sol can be used;

solvent (common in both layers): a general aqueous system or non-aqueous system solvent such as water, ethanol, isopropyl alcohol (IPA) can be used;

A dispersed material (common in both layers): there is no particular limitation, but a material suitable for a solvent may be appropriately added, thus, for example, polycarboxylic system (such as ammonium salt), phosphate ester system, and naphthalene sulfonic acid formalin condensate can be used.

In the inner protective layer 21, the pore diameter can be adjusted by adjusting the particle diameter of the pore forming material, and the degree of porosity can be adjusted by adjusting an amount of the pore forming material.

Applicable as a method of applying each slurry are various methods such as dipping coating, spin coating, spray coating, slit die coating, thermal spraying, AD method, and printing method.

For example, when slurry is applied by dipping coating, the following conditions are exemplified.

Viscosity of Slurry:
For forming the outer protective layer: 10 mPa·s to 5000 mPa·s;
For forming the inner protective layer: 500 mPa·s to 7000 mPa·s;

Retracting speed: 0.1 mm/s to 10 mm/s;

Drying temperature: room temperature to 300° C.;

Drying time: one minute or more.

Conditions of firing performed after applying slurry are exemplified as follows.

Firing temperature: 800° C. to 1200° C.;

Firing time: 0.5 hours to 10 hours;

Firing atmosphere: atmospheric air.

The sensor element 10 obtained by the above procedure is housed in a predetermined housing, and built into the body, which is not illustrated, of the gas sensor 100.

As described above, according to the present embodiment, the degree of porosity of the inner protective layer is set to 30% to 85% to have the larger value than the degree of porosity of the outer protective layer and the average fine pore diameter is set to equal to or larger than 0.5 μm and equal to or smaller than 5.0 μm in the case where the leading-end protective layer made up of the two layers of the outer protective layer and the inner protective layer is provided in a portion near the end portion, on the side in which the gas induction inlet is provided, of the sensor element of the gas sensor, thus even when there is no difference in the water resistance property of the outer protective layer, the water resistance property in the sensor element is increased compared with a case where the average fine pore diameter exceeds 5.0 μm. For example, when the outer protective layer has the water-repellent property, the sensor element appropriately suppressing the ingress of water inside is achieved.

### Modification Example

The above-mentioned embodiments are targeted at a sensor element having three internal chambers, but the sensor element may not necessarily have a three-chamber configuration. That is to say, the configuration that the outer protective layer of the sensor element is a water-repellent layer by the lotus effect is also applicable to a sensor element having two or one internal chamber.

In the above-mentioned embodiment, firing is performed after the application of slurry for forming the inner protective layer and slurry for forming the outer protective layer to form the two protective layers at the same time, however, also applicable instead is a configuration that firing is performed once when slurry for forming the inner protective layer is applied to form the inner protective layer, and then firing is performed after slurry for forming the outer protective layer is applied to form the outer protective layer.

The configuration that the leading-end protective layer in the sensor element of the gas sensor is made up of the two layers of the outer protective layer and the inner protective layer, the degree of porosity of the inner protective layer is set to 30% to 85% to have the larger value than the degree of porosity of the outer protective layer, and the average fine pore diameter is set to equal to or larger than 0.5 μm and equal to or smaller than 5.0 μm to increase the water resistance property of the sensor element is applicable not only to an elongated planar limiting current sensor element having the above-mentioned configuration, but also to various types of ceramic sensor element in which the water-induced cracking may occur regardless of whether a detection part of detecting a target detection gas component is located inside or located to be exposed outside. Furthermore, the above-mentioned configuration may be applied not only to the sensor element but also a general ceramic structured body. The configuration similar to that of the present embodiment may be applied when the increase in strength or thermal insulation is desired even in a sensor element or a ceramic structured body in which the water-induced cracking does not cause a problem.

Obviously, when the protective layer of the general ceramic structured body is made up of the two layers of the outer protective layer and the inner protective layer as described above, an underlying layer thereof needs not have a structure as the sensor element.

The ceramic structured body of the present invention, that is to say, the ceramic structured body provided with the protective layer made up of the two layers of the outer protective layer and the inner protective layer, having the degree of porosity of the inner protective layer of 30% to 85% which is the larger value than the degree of porosity of the outer protective layer, and having the average fine pore diameter equal to or larger than 0.5 μm and equal to or smaller than 5.0 μm may be used for a purpose other than the sensor element 10. For example, a ceramic structured body having the above-mentioned protective layer can be used as a setter for firing requiring a high thermal shock resistance property.

### EXAMPLES

With an intention of manufacturing sensor elements having different average fine pore diameters of the inner protective layer 21, seventeen types of slurry for the inner protective layer with different particle diameters of the pore forming material added in manufacturing slurry for the inner protective layer were manufactured, and the inner protective layers 21 were formed using those types of slurry to manufacture seventeen types of sensor element 10 (sample Nos. 1 to 17).

At that time, the particle diameter of the pore forming material was increased in numerical order in the sample Nos. 1 to 10, and adjusted was an amount of the pore forming material on an assumption that the sample No. 1 had a degree of porosity of approximately 20%, the sample No. 2 had a degree of porosity of approximately 35%, and each of the sample Nos. 3 to 10 had a degree of porosity equal to or larger than 50% and equal to or smaller than 60%. In the meanwhile, the particle diameter of the pore forming material used for manufacturing the sensor element was increased in numerical order in the sample Nos. 11 to 17, and adjusted was an amount of the pore forming material on an assumption that a degree of porosity was equal to or larger than 60% and equal to or smaller than 70%.

Specifically, a powder of alumina planar particles (average particle diameter of 6 μm) as a material of an aggregate and a powder of titania microparticles (average particle diameter of 0.25 μm) as a material of a binding material were firstly weighted so that a weight ratio of them satisfies a coarse particle powder:microparticle powder=1:1 to manufacture slurry for the inner protective layer for each sample. These powders, alumina sol as an inorganic binder, acrylic resin of each particle diameter as a pore forming material, and ethanol as a solvent were combined by a pot mill to obtain four types of slurry for the inner protective layer. A mixing amount of alumina sol is 10 wt % of a total weight of the alumina powder and the titania powder.

A spinel powder (average particle diameter of 20 μm) as a coarse particle powder and a magnesia powder (average particle diameter of 0.05 μm) as a microparticle powder were weighted so that a weight ratio of them satisfies a coarse particle powder:microparticle powder=20:1 to manufacture slurry for the outer protective layer. These powders, alumina sol as an inorganic binder, polycarboxylic ammonium salt as a dispersing agent, and water as a solvent were mixed by a rotating and revolving mixer to obtain slurry for forming the outer protective layer. A mixing amount of alumina sol is 10 wt % of a total weight of the alumina powder and the titania powder. A mixing amount of polycarboxylic ammonium salt is 4 wt % of a weight of the microparticle powder.

Seventeen types of slurry for the inner protective layer manufactured in the above-mentioned manner were applied with a thickness of 300 μm to a formation target location of the inner protective layer 21 in the element base 1 which had been manufactured in advance by a known method by dipping coating. Subsequently, the element base 1 was dried for one hour in a drying machine being set to 200° C.

Next, slurry for the outer protective layer manufactured in the above-mentioned manner was applied with a thickness of 300 μm to a formation target location of the outer protective layer 22 in each element base 1, which had been dried, by dipping coating. Subsequently, each element base 1 was dried for one hour in a drying machine being set to 200° C.

Finally, each element base 1 was fired for three hours at firing temperature of 1100° C. in the atmosphere to complete seventeen types of sensor element 10 (No. 1 to No. 17) including the inner protective layer 21 and the outer protective layer 22.

When each outer protective layer 22 of the obtained seventeen types of sensor element 10 was observed by a SEM, confirmed was a configuration that the coarse grains 22c around which the numerous minute convex parts made up of the microparticles 22f were discretely formed were sintered via the microparticles 22f. A size of the convex part is approximately 50 nm to 500 nm, and an interval between the concave parts is approximately 100 nm to 1000 nm.

Also confirmed was that the coarse grains 22c were spinel and the microparticles 22f were magnesia by a constitution analysis using an energy dispersive X-ray spectroscopy (EDS) and an X-ray diffractometer (XRD).

The above results indicate that there is not a significant difference between the sensor elements 10 of No. 1 to No. 17 with respect to the outer protective layer 22.

Furthermore, the inner protective layer 21 was exposed in each of the sensor elements 10 of No. 1 to No. 17, and the degree of porosity of the inner protective layer 21 was calculated based on a SEM image of an exposure surface.

The average fine pore diameter in the exposure surface as a target was measured by an image analysis.

In addition, a water resistance test was performed on each of the sensor elements 10 of No. 1 to No. 17.

Specifically, electrical power was applied to the heater 150 to maintain the heating state of the sensor element 10, and the pump cells and, further, the sensor cells of the sensor element 10 were operated in ambient atmosphere to perform control so that oxygen concentration in the first internal chamber 102 was maintained at a predetermined constant value to thereby obtain a situation in which a pump current Ip0 in the main pump cell P1 was stabilized.

Under the situation, a predetermined amount of water was dropped onto the outer protective layer 22, and whether a change of the pump current Ip0 before and after dropping exceeded a predetermined threshold was determined. If the change of the pump current Ip0 did not exceed the threshold, the amount of dropped water was increased to repeat the determination. The amount of dropped water when the change of the pump current Ip0 eventually exceeded the threshold was defined as a water exposure limit amount, and water resistance or a lack thereof was determined based on the magnitude of a value of the water exposure limit amount. Specifically, the sensor element 10 was determined to have excellent water resistance if the water exposure limit amount was 20 μL or more. Particularly, the sensor element 10 was determined to have extremely excellent water resistance if the water exposure limit amount was 30 μL or more.

In this test, the change of the pump current Ip0 was used as a criterion for determining the occurrence of cracking in the element base 1. This utilizes such a causal relationship that, when cracking of the element base 1 occurs due to thermal shock caused by dropping (adherence) of water droplets onto the outer protective layer 22, oxygen flows into the first internal chamber 102 through a portion of the cracking, and the value of the pump current Ip0 increases.

Also visually confirmed together was whether a cracking or a peeling (delamination) did not occur in the leading-end protective layer 2 in performing the water resistance test.

Furthermore, some of the seventeen types of slurry for the inner protective layer described above (specifically, eleven types of slurry No. 1, No. 3, No. 5, No. 6, No. 8, No. 10, No. 11, and No. 13 to No. 16) were dried in the same condition as that in manufacturing, and further degreased and fired to manufacture pellets each having a diameter of 10 mm and a thickness of 1 mm A thermal conductivity at room temperature was obtained for the eleven types of pellet thus obtained.

Specifically, a density of each manufactured bulk body was measured by a mercury porosimeter, a specific heat was measured by differential scanning calorimetry (DSC) method, and a thermal diffusion ratio was measured by laser flush method to calculate the thermal conductivity by the following relational expression.

Thermal conductivity=thermal diffusion ratio×specific heat×density

A value thus obtained can be considered a quasi-thermal conductivity of the inner protective layer 21 in the eleven types of sensor element 10 at room temperature. The thermal conductivity hereinafter indicates a value at room temperature. In the present embodiment, a degree of thermal insulation of the inner protective layer was determined based on a magnitude of the value of the thermal conductivity.

Specifically, when the thermal conductivity was equal to or smaller than 0.6 W/m·K, the inner protective layer was considered to have the excellent thermal insulation property. Particularly, when the thermal conductivity was equal to or smaller than 0.3 W/m·K, the inner protective layer was considered to have the extremely excellent thermal insulation property.

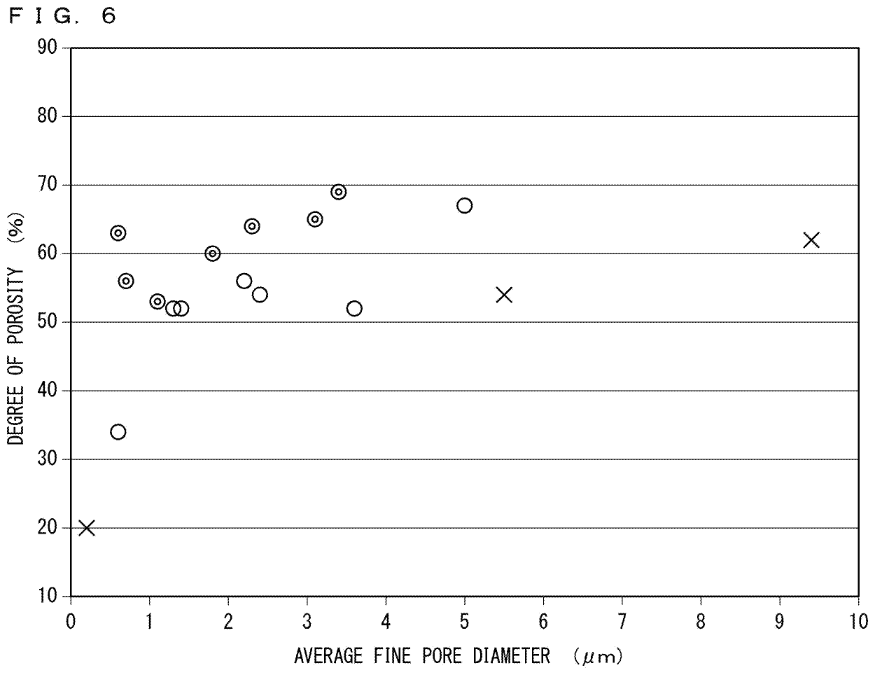

Table 1 lists the average fine pore diameter and the degree of porosity of the inner protective layer 21, the presence or absence of the cracking and the delamination in the inner protective layer 21 during the water resistance test, and the evaluation results of the water exposure limit amount (“water resistance property” in Table 1) for the sensor elements 10 of No. 1 to No. 17, and additionally lists the evaluation results of the calculated thermal conductivity. FIG. 6 is a diagram of plotting a measurement result of the sensor elements 10 of No. 1 to No. 17 illustrated in Table 1, a lateral axis indicating the average fine pore diameter and a vertical axis indicating the degree of porosity.

TABLE 1

| | Average fine | | Cracking and | | |
|---|---|---|---|---|---|
| | pore diameter | Degree of | delamination in | Water resistance | Thermal |
| Sample No. | (μm) | porosity (%) | water exposure | property | conductivity |
| 1 | 0.2 | 20 | Absence | X | X |
| 2 | 0.6 | 34 | Absence | ◯ | |
| 3 | 0.7 | 56 | Absence | ⊚ | ⊚ |
| 4 | 1.1 | 53 | Absence | ⊚ | |
| 5 | 1.3 | 52 | Absence | ◯ | ◯ |
| 6 | 1.4 | 52 | Absence | ◯ | ◯ |
| 7 | 2.2 | 56 | Absence | ◯ | |
| 8 | 2.4 | 54 | Absence | ◯ | ◯ |
| 9 | 3.6 | 52 | Absence | ◯ | |
| 10 | 5.5 | 54 | Presence | X | X |
| 11 | 0.6 | 63 | Absence | ⊚ | ⊚ |
| 12 | 1.8 | 60 | Absence | ⊚ | |
| 13 | 2.3 | 64 | Absence | ⊚ | ⊚ |
| 14 | 3.1 | 65 | Absence | ⊚ | ⊚ |
| 15 | 3.4 | 69 | Absence | ⊚ | ⊚ |
| 16 | 5.0 | 67 | Absence | ◯ | ◯ |
| 17 | 9.4 | 62 | Absence | X | |

In the list of “water resistance” in Table 1 and FIG. 6, the samples each having the water exposure limit amount equal to or larger than 30 μL and thus determined to have the extremely preferable water resistance are each marked with the double circle. The samples each having the water exposure limit amount equal to or larger than 20 μL and smaller than 30 μL and thus determined to have the preferable water resistance are each marked with the single circle. The samples each having the water exposure limit amount smaller than 20 μL and do not fall under any of the above conditions are each marked with the cross.

In the list of “thermal conductivity” in Table 1, the samples each having the thermal conductivity equal to or smaller than 0.3 W/m·K and thus determined to have the extremely preferable thermal insulation property are each marked with the double circle. The samples each having the thermal conductivity equal to or larger than 0.3 W/m·K and smaller than 0.6 W/m·K and thus determined to have the preferable thermal insulation property are each marked with the single circle. The samples each having the thermal conductivity equal to or larger than 0.6 W/m·K and do not fall under any of the above conditions are each marked with the cross.

As shown by Table 1, the sample has the larger average fine pore diameter of the inner protective layer 21 in the samples of No. 1 to No. 10 and the samples of No. 11 to No. 17 as the number thereof increases, that is to say, as the particle diameter of the pore forming material increases.

The degree of porosity was substantially within the scope of the assumption. The samples No. 3 to No. 10 having the degree of porosity equal to or larger than 50% and smaller than 60% are referred to as a first sample group and the samples No. 11 to No. 17 having the degree of porosity equal to or larger than 60% and equal to or smaller than 70% are referred to as a second sample group hereinafter. There was no specific correlation between the degree of porosity and the average fine pore diameter in any of the first sample group and the second sample group.

Next, the preferable or the extremely preferable result was obtained as for “the water resistance property” except for the samples of No. 1, No. 10, and No. 17.

Obtained particularly in the first sample group was a result that the sample having the smaller average fine pore diameter of the inner protective layer had the more preferable result. Specifically, the samples No. 3 and No. 4 having the smallest and the second smallest average fine pore diameters of 0.7 μm and 1.1 μm, respectively, in the first sample group were determined to have the extremely preferable water resistance property. In contrast, the sample No. 10 having the largest average fine pore diameter of 5.5 μm in the first sample group had the water resistance value lower than 20 μL, and moreover, the occurrence of the cracking and the delamination was visually confirmed during the water resistance test only in the sample No. 10.

Obtained also in the second sample group was a result that the sample having the smaller average fine pore diameter of the inner protective layer had the more preferable water resistance property in the manner similar to the first sample group. However, in the second sample group, a range of the average fine pore diameter which had been determined to have the extremely preferable water resistance was 0.6 μm to 3.4 μm which was larger than the case of the first sample group. Specifically, the samples No. 11 to 15 belong to the range. The sample No. 16 having the average fine pore diameter of 0.5 μm was also determined to have the preferable water resistance. Only the sample No. 17 having the largest average fine pore diameter of 9.4 μm in the second sample group had the water resistance value lower than 20 μL, however, the occurrence of the cracking and the delamination was not visually confirmed during the water resistance test.

The above tendency is comprehensively grasped from FIG. 6. That is to say, according to FIG. 6, confirmed is a tendency that the sensor element 10 having the inner protective layer 21 with the smaller average fine pore diameter and the sensor element 10 having the inner protective layer 21 with the larger degree of porosity have more excellent water resistance property.

Confirmed furthermore is that when the average fine pore diameter is 0.6 μm to 3.4 μm, the sensor element 10 having the extremely preferable water resistance is achieved by setting the degree of porosity to an appropriate value according to the average fine pore diameter, and when the degree of porosity is equal to or larger than 50% and equal to or smaller than 70%, the sensor element 10 having the extremely preferable water resistance is achieved by setting the average fine pore diameter to an appropriate value according to the degree of porosity.

More specifically, confirmed that when the average fine pore diameter is 0.6 μm to 3.4 μm and the degree of porosity is equal to or larger than 60% and equal to or smaller than 70%, the sensor element 10 having the extremely preferable water resistance is achieved.

Confirmed furthermore is a tendency that the sample having the smaller average fine pore diameter roughly has the smaller value of “thermal conductivity” in Table 1 in any cases where the samples belonging to the first sample group having substantially the same degree of porosity are compared and the samples belonging to the second sample group also having substantially the same degree of porosity are compared.

When the first sample group and the second sample group are compared, also confirmed is a tendency that the second sample group has the larger range of average fine pore diameter, which is determined to have the small thermal conductivity, than the first sample group. Also in consideration of the result that the thermal conductivity is large in the sample No. 1 in which the average fine pore diameter is 0.2 μm which is the smallest in all of the samples and the degree of porosity is 20% which is also the smallest in all of the samples, it can be considered that the inner protective layer tends to have the smaller thermal conductivity as the degree of porosity increases, and have the smaller thermal conductivity as the average fine pore diameter decreases when the degree of porosity is substantially the same.

Considering these results and the measurement results on the water resistance property, confirmed is that the degree of porosity is increased in the range of 30% to 85% and the average fine pore diameter is reduced in the range of 0.5 μm to 5.0 μm, thus the sensor element 10 having increased thermal insulation by reducing the thermal conductivity is excellent in the water resistance property.

The above results indicate that in the sensor element 10, when the conditions of forming the inner protective layer 21 (specifically, the particle diameter of the pore forming material) is changed, the difference in the water resistance property occurs even if there is no difference in the configuration of forming the outer protective layer 22 and the degree of porosity of the inner protective layer. Specifically, the above results indicate that when the degree of porosity of the inner protective layer 21 is 30% to 85% and the average fine pore diameter is equal to or larger than 0.5 μm and equal to or smaller than 5 μm, the excellent water resistance property in which the water exposure limit amount equal to or larger than 20 μL can be achieved in the sensor element 10. Specifically, the above results indicate that when the average fine pore diameter is 0.6 μm to 3.4 μm and the degree of porosity is equal to or larger than 60% and equal to or smaller than 70%, the sensor element 10 having the water exposure limit amount equal to or larger than 30 μL, thereby having the extremely preferable water resistance is achieved.

What is claimed is:

1. A ceramic structured body, comprising
a first porous layer in at least a part of an outermost peripheral portion; and
a second porous layer having a degree of porosity of 30% to 85%, which is larger than a degree of porosity of the first porous layer, inside the first porous layer, wherein
an average fine pore diameter of the second porous layer is equal to or larger than 0.5 μm and equal to or smaller than 5.0 μm.

2. The ceramic structured body according to claim 1, wherein
the second porous layer includes:
aggregate particles each having a diameter of 1.0 μm to 10 μm; and
binding material particles each having a diameter equal to or larger 10 nm and equal to or smaller than 1.0 μm.

3. The ceramic structured body according to claim 2, wherein
the aggregate particles are particles of at least one oxide selected from a group of alumina, spinel, titania, zirconia, magnesia, mullite, and cordierite, and
the binding material particles are particles of at least one oxide selected from a group of alumina, spinel, titania, zirconia, magnesia, mullite, and cordierite.

4. The ceramic structured body according to claim 1, wherein
a degree of porosity of the second porous layer is 50% to 70%.

5. The ceramic structured body according to claim 1, wherein
an average fine pore diameter of the second porous layer is equal to or larger than 0.6 μm and equal to or smaller than 3.4 μm.

6. The ceramic structured body according to claim 5, wherein
a degree of porosity of the second porous layer is 60% to 70%.

7. A sensor element of a gas sensor, comprising:
an element base which is a ceramic structured body including a detection part of detecting a target measurement gas component;
an outer protective layer which is a porous layer provided in at least a part of an outermost peripheral portion of the element base; and
an inner protective layer which is a porous layer having a degree of porosity of 30% to 85%, which is larger than a degree of porosity of the outer protective layer, inside the outer protective layer, wherein
an average fine pore diameter of the inner protective layer is equal to or larger than 0.5 μm and equal to or smaller than 5.0 μm.

8. The sensor element of a gas sensor according to claim 7, wherein
the second porous layer includes:
aggregate particles each having a diameter of 1.0 μm to 10 μm; and
binding material particles each having a diameter equal to or larger 10 nm and equal to or smaller than 1.0 μm.

9. The sensor element of a gas sensor according to claim 8, wherein
the aggregate particles are particles of at least one oxide selected from a group of alumina, spinel, titania, zirconia, magnesia, mullite, and cordierite, and
the binding material particles are particles of at least one oxide selected from a group of alumina, spinel, titania, zirconia, magnesia, mullite, and cordierite.

10. The sensor element of a gas sensor according to claim 7, wherein
a degree of porosity of the second porous layer is 50% to 70%.

11. The sensor element of a gas sensor according to claim 7, wherein
an average fine pore diameter of the second porous layer is equal to or larger than 0.6 μm and equal to or smaller than 3.4 μm.

12. The sensor element of a gas sensor according to claim 11, wherein
a degree of porosity of the second porous layer is 60% to 70%.

13. The ceramic structured body according to claim 2, wherein
a degree of porosity of the second porous layer is 50% to 70%.

14. The ceramic structured body according to claim 3, wherein
a degree of porosity of the second porous layer is 50% to 70%.

15. The ceramic structured body according to claim 2, wherein
an average fine pore diameter of the second porous layer is equal to or larger than 0.6 μm and equal to or smaller than 3.4 μm.

16. The ceramic structured body according to claim 3, wherein
an average fine pore diameter of the second porous layer is equal to or larger than 0.6 μm and equal to or smaller than 3.4 μm.

17. The sensor element of a gas sensor according to claim 8, wherein
a degree of porosity of the second porous layer is 50% to 70%.

18. The sensor element of a gas sensor according to claim 9, wherein
a degree of porosity of the second porous layer is 50% to 70%.

19. The sensor element of a gas sensor according to claim 8, wherein
an average fine pore diameter of the second porous layer is equal to or larger than 0.6 μm and equal to or smaller than 3.4 μm.

20. The sensor element of a gas sensor according to claim 9, wherein
an average fine pore diameter of the second porous layer is equal to or larger than 0.6 μm and equal to or smaller than 3.4 μm.
